(19) United States
(12) Patent Application Publication
(10) Pub. No.: US 2007/0255778 A1
(43) Pub. Date: Nov. 1, 2007

(54) Software method for solving systems of linear equations having integer variables

(76) Inventor: Jean-Paul Theis, Erpeldange (LU)

Correspondence Address: Jean-Paul Theis, Porte des Ardennes, 1, Erpeldange, L-9145, LU

(21) Appl. No.: 11/412,135

(22) Filed: Apr. 27, 2006

(51) Int. Cl. G06F 7/38

(52) U.S. Cl. 708/446

(57) ABSTRACT

This invention describes a software method for computers for solving integer programming problems containing systems of linear equations where part of or all of the variables may take only integer values. Said software method consists of 3 main steps. First, all of or part of said system is regularized such that the variable-coefficients of the regularized part of said system satisfy some well defined properties. In a second step, parameterized solutions are computed for each equation of said system. In a third step, solutions to said system are determined by finding solutions which are common to all equations of said system. Furthermore, the solutions of an equation of said system may be determined by sorting two or more of the variable-coefficients of a said equation according to ascending or descending magnitude. Finally, prior to executing said 3 steps, said system may be conditioned such any variable-coefficient of the system is non-zero.

### FIELD OF THE INVENTION

This invention describes a software method for computers for solving integer programming problems containing systems of linear equations where part of the variables may take only integer values. Integer programming has many different practical applications, e.g. in production cost optimization, product development, logistics and business methods.

### PRIOR ART

Integer programming is a special case of linear programming where the variables (or unknowns) can take only integer values. Whereas efficient algorithms for linear programming has been developed as early as 1950, e.g. the simplex algorithm, integer programming appeared far more hard to implement efficiently. In average, the simplex algorithm has polynomial complexity. The complexity of an algorithm is measured in terms of basic operations the algorithm has to execute in order to solve a problem. Polynomial complexity means that the number of operations grows like O((n·k)^{c}), where O( ) denotes the mathematical sign for ‘order of magnitude’, n denotes the number of variables and k denotes the number of equations, and c is a constant whose value does not depend on n.

For integer programming, no polynomial complexity algorithm is known. State-of-the-art algorithms include branch-and-bound methods, cutting plane (Gomory) methods and explicit/implicit enumeration methods. All of these algorithms have exponential complexity and have an unacceptable run-time for optimization problems involving a few thousand variables.

Integer programming has numerous practical applications. One of the most famous is the traveling sales man problem where a salesman has to visit a certain number of clients at different locations within a given period of time. The underlying optimization problem consists in finding the optimal route such the clients visited within the given time are maximized. The traveling sales man problem can be generalized to other optimization problems common in logistics and transportation, which is also closely related to business methods for logistic and transportation companies.

Another field of applications of integer programming is that of production line optimization, e.g. where a robot-controlled production line consisting of a number of robots able to assemble a certain number of products. Each product requires a different number of assembly steps on each robot. The underlying optimization problem consists in distributing the assembly steps of each product to the different robots such that the total number of assembly steps(=production costs) is minimized and the total number of products assembled in a certain time(=sales revenues) is maximized.

Another important field of application is product development, in particular chip design in the semiconductor industry. Chip design requires electronic design automation (EDA) tools for placement and routing of the semiconductor devices, e.g. transistors or logic gates, on a silicon die. A common flavor of the underlying optimization problem often consists in placing and routing the transistors on the silicon die in such a way that the total area occupied by the transistors is minimized(=minimization of the production costs) and the sum of all wires connecting the transistors with each other is minimized(=maximization of the operating speed).

### DETAILED DESCRIPTION OF THE INVENTION

The present invention describes a new and efficient algorithm for integer programming.

The description of the invention aims at keeping the burden of mathematical notation and formalism at a minimum and giving, wherever possible, the priority to small and constructive examples from which the formal algorithm becomes obvious.

Consider the integer minimization problem consisting of a system of k linear equations of the form a_{1,l}·x₁+ . . . +a_{n,l}·xₙ=bₗ, l=1, . . . k, having n binary variables xₘ m=1 . . . n, coupled to an objective function min Σₘ₌1 . . . n cₘ·xₘ. The coefficients a_{j,l}, cⱼ and bₗ, j=1, . . . n, l=1, . . . k, belong to the set of positive and negative integers. Each binary variable xₗ, l=1 . . . n can take the value 0 or 1. For notational convenience, the coefficients a_{j,l} j=1, . . . n, l=1, . . . k will be called ‘variable-coefficients’.

The complexity of the algorithm is given in terms of the following basic operations (or steps):
1. basic arithmetic and relational operators (e.g. multiplication ‘·’, addition ‘+’, subtraction ‘−’, division with or without rest ‘/’, bigger or equal to ‘>=’, smaller or equal to ‘<=’, equal to ‘=’, different from ‘≠’, element of ‘∈’, included in ‘⊂’, union ‘∪’) taking as arguments either coefficients, variable labels, or words of up to O(n·log n) bits
2. bitwise logical operators (e.g. bitwise AND, OR, NOT) taking as arguments words of up to O(n·log n) bits
3. read/write accesses to random access memories having O(n) entries and storing up to O(n·log n) bits per entry

Unless specified otherwise, ‘log’ denotes the logarithm of base 2.

Without loss of generality (w.l.o.g.) it is assumed that each binary variable xₗ l=1 . . . n has at least one non-zero coefficient a_{l,k} in one or more of the k equations. First, the above system is ‘conditioned’, e.g. the system is transformed into an equivalent system having only non-zero variable-coefficients. ‘Conditioning’ has complexity O(k·n²). An algorithm for conditioning a given system is found at the end of this section.

The algorithm for solving the above integer minimization problem consists of 3 main steps:
1. The conditioned system is ‘regularized’. By definition, a system is called ‘regularized’ if and only if (iif) the coefficients a_{m,l} m=1, . . . n, l=1, . . . k satisfy the following 3 conditions for any two equations i, j:
   if for any m,n: a_{m,i}=a_{n,i} then a_{m,j}=a_{n,j} a
   if for any m,n: a_{m,i}≠a_{n,i} then a_{m,j}≠a_{n,j} b
   for any m,l: a_{m,l}≠0 c
‘Regularization’, e.g. the transformation of a conditioned system into an equivalent regularized system, has complexity bounded by O(k·n²).
2. Solutions are computed for each equation of the regularized system separately. Empirical data suggest that finding all the solutions of an equation has average complexity around O(n²·log n).
3. All solutions to the regularized system are computed by determining the solutions which are ‘common’ to all equations. Finally, only the solutions which minimize the objective function are retained. Regularization assures that this step has average complexity around O(n²·k·log(n·k)).

Each step is now described in detail.

Step 1: Regularization

The k equations of the conditioned system are labeled 1, . . . k, e.g. equation k meaning the k^{th} equation of the system. Consider any two equations i and j. Define two sets S1_{i,j} and S2^{i,j} as follows:
a variable xₘ belongs to S1_{i,j} if one of the following 2 conditions is satisfied:
   a_{m,i}≠a_{i,j} for all l ∈ {1, . . . n}, l≠m a.
   if a_{m,i}=a_{l,i} for some l ∈ {1, . . . n}, l≠m then a_{m,j}≠a_{i,j} b.
S2_{i,j} contains all other variables

It is useful to note that S1_{i,j}≡S1_{j,i} and S2_{i,j}≡S2_{j,i}. Determining S1_{i,j} has complexity bounded by O(n²) because O(n²) pair-wise comparisons between coefficients are required.

### EXAMPLE

### Consider Two Equations i, j

$$i \text{:} - 3 \cdot {x}_{1} - 4 \cdot {x}_{2} + 2 \cdot {x}_{3} + {x}_{4} + 7 \cdot {x}_{5} - 4 \cdot {x}_{6 } + 2 \cdot {x}_{7} = 3$$

$$j \text{:} {x}_{1} - 3 \cdot {x}_{2} + 2 \cdot {x}_{3} + {x}_{4} - 5 \cdot {x}_{5} - 3 \cdot {x}_{6} + 2 \cdot {x}_{7} = - 1$$

$$S {1}_{i , j} = \{ {x}_{1} , {x}_{4} , {x}_{5} \}$$

$$S {2}_{i , j} = \{ {x}_{2} , {x}_{3} , {x}_{6} , {x}_{7 } \}$$

Theorem:

Consider any two equations i, j with their sets S1_{i,j} and S2_{i,j}. There exist two integers a, b such that if equation i is substituted by the sum of equation i multiplied by a and of equation j multiplied by b, then all the variables belonging to the set S1_{i′,j} of substituted equation i′ and equation j have pair-wise different and non-zero coefficients. Finding the integers a, b has complexity bounded by O(n²).

Proof and Algorithm:

For notational convenience, the coefficients of equations i, j are temporarily denoted by c_{l,i} and c_{l,j} for l=1, . . . n respectively. The integers a, b must be such that for any m, l=1, . . . n, l≠m:

$$\begin{matrix}a \cdot {c}_{l , i} + b \cdot {c}_{l , j} \neq a \cdot {c}_{m , i} + b \cdot {c}_{m , j} ⇔ \\ a \cdot ( {c}_{l , i} - {c}_{m , i} ) \neq - b \cdot ( {c}_{l , j} - {c}_{m , j} ) ⇔ \\ a \neq - b \cdot ( {c}_{l , j } - {c}_{m , j} ) / ( {c}_{l , i} - {c}_{m , i} ) & ( 1 ) \\ and for any l = 1 , … n \text{:} \\ a \cdot {c}_{l , i} + b \cdot {c}_{l , j} \neq 0 ⇔ \\ a \neq - b \cdot {c}_{l , j} / {c}_{l , i} & ( 2 )\end{matrix}$$

There are at most ½·(n−1)·n inequalities of type (1) and at most n inequalities of type (2). a, b have to be chosen such that these inequalities are satisfied. One possible way to do so is to set b=−1, to compute the biggest number (denoted by K) of the ½·(n−1)·n numbers └(c_{l,j}−c_{m,j})/(c_{l,i}−c_{m,i})┘ m=1, . . . n, l=m+1 . . . n and of the n numbers └c_{l,j}/c_{l,i}┘, l=1, . . . n, and setting a=K+1. This would yield a complexity bounded by ½·(n−1)·n+n divisions and comparisons. It has the disadvantage of a potentially large integer a. An alternative would consist in sorting the list of these ½·(n−1)·n+n numbers and setting a equal to the smallest positive (or negative) integer not occurring in the sorted list. However, this would require a complexity of O(n²·log n).□

The theorem may also be applied to the substituted equation i′ and equation j to determine another pair of integers a′, b′ in order to substitute equation j by the sum of equation i′ multiplied by a′ and of equation j multiplied by b′ such that all the variables appearing in the substituted equation j′ and belonging to set S1_{i′,j′} have pair-wise different and non-zero coefficients.

Furthermore, the definition of set S2_{i′,j′} implies that the coefficients of the variables belonging to set S2_{i′,j′} satisfy:
if a_{m,i′}=a_{l,i′} for some l ∈ {1, . . . n}, l≠m then a_{m,j′}=a_{l,j′}

### EXAMPLE

The previous example shall illustrate how the theorem works in practice.

$$i \text{:} - 3 \cdot {x}_{1} - 4 \cdot {x}_{2} + 2 \cdot {x}_{3} + {x}_{4} + 7 \cdot {x}_{5} - 4 \cdot {x}_{6 } + 2 \cdot {x}_{7} = 3$$

$$j \text{:} {x}_{1} - 3 \cdot {x}_{2} + 2 \cdot {x}_{3} + {x}_{4} - 5 \cdot {x}_{5} - 3 \cdot {x}_{6} + 2 \cdot {x}_{7} = - 1$$

$$S {1}_{i , , j} = \{ {x}_{1} , {x}_{4} , {x}_{5} \}$$

$$S {2}_{ i , j} = \{ {x}_{2} , {x}_{3} , {x}_{6} , {x}_{7 } \}$$

Writing down all inequalities of type (1) yields:

$$a \cdot ( -- 6 ) \neq b \cdot ( - 6 )$$

$$a \cdot ( - 4 ) \neq 0$$

$$a \cdot ( - 10 ) \neq b \cdot 6$$

Writing down all inequalities of type (2) yields:

$$a \cdot ( - 3 ) + b \neq 0$$

$$a \cdot ( - 4 ) + b \cdot ( - 3 ) \neq 0$$

$$a \cdot 2 + b \cdot 2 \neq 0$$

$$a + b \neq 0$$

$$a \cdot 7 + b \cdot ( - 5 ) \neq 0$$

$$a \cdot ( - 4 ) + b \cdot ( - 3 ) \neq 0$$

a=1, b=2 is one possible solution and leads to the following substituted equation i′:

$${i}^{ ′} \text{:} - {x}_{1} - 10 \cdot {x}_{2} + 6 \cdot {x}_{3} + 3 \cdot {x}_{4} - 3 \cdot {x}_{5} - 10 \cdot {x}_{6 } + 6 \cdot {x}_{7} = 1$$

$$j \text{:} {x}_{1} - 3 \cdot {x}_{2} + 2 \cdot {x}_{3} + {x}_{4} - 5 \cdot {x}_{5} - 3 \cdot {x}_{6} + 2 \cdot {x}_{7} = - 1$$

$$S {1}_{{i}^{ ′} , j} = \{ {x}_{1} , {x}_{4} , {x}_{ 5} \}$$

$$S {2}_{{i}^{ ′} , j} = \{ {x}_{2} , {x}_{3} , {x}_{6} , {x}_{7 } \}$$

Applying the same theorem to equations i′ and j in order to substitute equation j yields for example a′=−1, b′=2. The substituted equations i′ and j′ are displayed in rearranged variable order such that the structure of the sets S1_{i′,j′} and S2_{i′,j′} becomes apparent.

$$S {2}_{{i}^{′} , {j}^{′}} = \{ {x}_{2} , {x}_{3} , {x}_{6} , {x}_{7 } \} S {1}_{{i}^{′} , {j}^{′}} = \{ {x}_{1} , {x}_{4} , {x}_{5} \}$$

$${i}^{ ′} \text{:} - \overbrace{10 \cdot {x}_{2} - 10 \cdot {x}_{6} + 6 \cdot {x}_{3} + 6 \cdot {x}_{7 }} - \overbrace{{x}_{1} + 3 \cdot {x}_{4} - 3 \cdot {x}_{5}} = 1$$

$${j}^{ ′} \text{:} 4 \cdot {x}_{2} + 4 \cdot {x}_{6} - 2 \cdot {x}_{3} - 2 \cdot {x}_{7} + 3 \cdot {x}_{1} - {x}_{4} - 7 \cdot {x}_{5} = - 3$$

Equations i′ and j′ form a regularized system because, by definition, set S1_{i′,j′} satisfies condition b, and set S2_{i′,j′} satisfies condition a. of a regularized system and because all variable-coefficients are non-zero.

The above procedure for transforming a conditioned system of two equations i, j into a regularized system can be extended to a conditioned system containing an arbitrary number of equations:
1. Apply the above theorem to the first and second equation of the system in order to get a first equation substituted for the first time (denoted by 1_{—}1) and a set S1₁_{_{—}}_{1,2} and a set S2₁_{_{—}}_{1,2}, then apply the theorem to equation 1_{—}1 and the 3^{rd} equation of the system in order to get a first equation substituted for the second time (denoted by 1_{—}2) and a set S1₁_{_{—}}_{2,3} ⊃ S1₁_{_{—}}_{1,2} and a set S2₁_{_{—}}_{2,3} ⊂ S2₁_{_{—}}_{1,2}, then apply the theorem to equation 1_{—}2 and the 4^{th} equation system in order to get a first equation substituted for the third time (denoted by 1_{—}3) and a set S1₁_{_{—}}_{3,4} ⊃ S1₁_{_{—}}_{2,3} and a set S2₁_{_{—}}_{3,4} ⊂ S2₁_{_{—}}_{2,3} . . . and so on, until the theorem is applied to equation 1_(k−2) and the k^{th} equation in order to get a first equation substituted for the (k−1)^{th} time (denoted by 1_(k−1)) and a set S1₁_{_{—}}_{(k-1),k} ⊃ S1₁_{_{—}}_{(k-2),k-1} and a set S2₁_{_{—}}_{(k-1),k} ⊂ S2₁_{_{—}}_{(k-2),k-1}. Define the set S1ₘₐₓ:=S1₁_{_{—}}_{(k-1),k} and the set S2ₘᵢₙ:=S2₁_{_{—}}_{(k-1),k}.
2. Apply the theorem to equation 1_(k−1) and the second equation to get a substituted second equation (denoted by 2_{—}1) having a set S1₁_{_{—}}_{(k-1),2}_{_{—}}₁=S1ₘₐₓ and a set S2₁_{_{—}}_{(k-1),2}_{_{—}}₁=S2ₘᵢₙ, then apply the theorem to equation 1_(k−1) and the third equation to get a substituted third equation (denoted by 3_{—}1) having a set S1₁_{_{—}}_{(k-1),3}_{_{—}}₁=S1ₘₐₓ and a set S2₁_{_{—}}_{(k-1),3}_{_{—}}₁=S2ₘᵢₙ . . . and so on, until the theorem has been applied to equation 1_(k−1) and the k^{th} equation to get a substituted k^{th} equation (denoted by k_{—}1) having a set S1₁_{_{—}}_{(k-1),k}_{_{—}}₁=S1ₘₐₓ and a set S2₁_{_{—}}₍ₖ₋₁₎ₖ_{_{—}}₁=S2ₘᵢₙ

Since the substitution of an equation has complexity O(n²) and since 2·k substitutions have to be done, the total complexity of steps 1. and 2. is O(k·n²).

### EXAMPLE

An example with 3 equations shall illustrate the sequence of substitutions. Equations i and j are taken from the previous example.
−3·x₁−4·x₂+2·x₃+x₄+7·x₅−4·x₆+2·x₇=3 i
x₁−3·x₂+2·x₃+x₄−5·x₅−3·x₆+2·x₇=−1 j
5·x₁−x₂+2·x₃+4·x₄−3·x₅−9·x₆+2·x₇=0 k

First, the theorem is applied to equations i and j in order to substitute equation i by equation i_{—}1 in the same way as for the previous example with 2 equations, which yields the following system
−x₁−10·x₂+6·x₃+3·x₄−3·x₅−10·x₆+6·x₇=1 i_{—}1
x₁−3·x₂+2·x₃+x₄−5·x₅−3·x₆+2·x₇=−1 j
5·x₁−x₂+2·x₃+4·x₄−3·x₅−9·x₆+2·x₇=0 k

In a second step, the theorem is applied to equations i_{—}1 and k in order to substitute equation i_{—}1 by the sum of equation k and equation i_{—}1, which yields the following system:
4·x₁−11·x₂+8·x₃+7·x₄−6·x₅−19·x₆+8·x₇=1 i_{—}2
x₁−3·x₂+2·x₃+x₄−5·x₅−3·x₆+2·x₇=−1 j
5·x₁−x₂+2·x₃+4·x₄−3·x₅−9·x₆+2·x₇=0 k

In a third step, the theorem is applied to equations i_{—}2 and j in order to substitute equation j by the sum of equation i_{—}2 and equation j, which yields the following system:
4·x₁−11·x₂+8·x₃+7·x₄−6·x₅−19·x₆+8·x₇−1 i_{—}2
5·x₁−14·x₂+10·x₃+8·x₄−11·x₅−22x₆+10·x₇=0 j_{—}1
5·x₁−x₂+2·x₃+4·x₄−3·x₅−9·x₆+2·x₇=0 k

In a last step, the theorem is applied to equations i_{—}2 and k in order to substitute equation k by the sum of equation i_{—}2 and equation k, which yields the following regularized system:

$$i\_ 2 \text{:} 8 \cdot {x}_{3} + 8 \cdot {x}_{7} + 4 \cdot {x}_{1} - 11 \cdot {x}_{2} + 7 \cdot {x}_{4} - 6 \cdot {x}_{5} - 19 \cdot {x}_{6} = 1$$

$$j\_ 1 \text{:} 10 \cdot {x}_{3} + 10 \cdot {x}_{7} + 5 \cdot {x}_{1} - 14 \cdot {x}_{2} + 8 \cdot {x}_{4} - 11 \cdot {x}_{5} - 22 \cdot {x}_{6 } = 0$$

$$k\_ 1 \text{:} \underbrace{10 \cdot {x}_{3} + 10 \cdot {x}_{7}} + \underbrace{9 \cdot {x}_{1} - 12 \cdot {x}_{2} + 11 \cdot {x}_{4} - 9 \cdot {x}_{5} - 28 \cdot {x}_{6} =} 1$$

$$S {2}_{ min} = \{ {x}_{3} , {x}_{7 } \} S {1}_{ max} = \{ {x}_{1} , {x}_{2} , {x}_{4} , {x}_{5} , {x}_{6} \}$$

Important Remark:

The set S2ₘᵢₙ is common to all equations of the regularized system and may contain one or more sub-sets of variables having identical coefficients. E.g. for the above example with 2 equations, S2ₘᵢₙ={x₂, x₃, x₆ , x₇} contains two subsets: {x₂, x₆} and {x₃, x₇}. If S2ₘᵢₙ has v elements, then S2ₘᵢₙ contains at most up to └v/2┘ sub-sets. In step 2 which follows, it will be shown that these sub-sets will be parameterized in order to specify parameterized solutions of equations.

Step 2: Computing All Solutions of a Linear Equation

Described is first an algorithm which finds all solutions of an equation having pair-wise different and positive coefficients. The algorithm is then extended to equations having one or more identical coefficients and positive or negative coefficients.

The working principle shall be illustrated by a small example. Consider a linear equation of the form a₁·x₁+ . . . +aₙ·xₙ=d with n=11 binary variables having the following integer coefficients aᵢ i=1 . . . 11 (sorted in descending magnitude or absolute value): 83, 55, 34, 30, 28, 11, 9, 7, 6, 3, 1. Wanted are all the solutions of the equation which are equal to the given number d, e.g. d=127.

For notational convenience, the coefficients in the sorted list are labeled in ascending order k, k=1 . . . 11, e.g. coefficient cₖ meaning the k^{th} coefficient in the sorted list. For each coefficient cₖ, compute the set Σₖ:=Σ_{m=k . . . n} cₘ, which requires O(n²) additions in total.

Each member of the sorted list of coefficients Lₒ contains:
1. the associated coefficient cₖ
2. the associated set Σₖ
3. the label k of the associated variable xₖ.

The first member in the list has label k=1 and contains the coefficient with biggest magnitude, the last member in the list has label k=n and contains the coefficient with smallest magnitude.

In the following algorithm specification, the steps are labeled by 1., 2., 3. . . . and have to be executed in the indicated order unless specified otherwise by a ‘goto’ statement.

Algorithm:
1. set m′=m=flag=0; the stacks Lₕ and Lₛ are empty;
2. do a binary search among all subsequent members in the list Lₒ (e.g. among members having labels>m′) to find the member with smallest label (e.g. with biggest associated coefficient), denoted by k, whose associated set Σₖ satisfies Σₖ>=d and whose coefficient cₖ satisfies cₖ<=d;
3. if member k exists then goto step 4, else set flag=1 and goto step 7;
4. set d=d−cₖ; store the label of the associated variable together with the value of d as a stack element on top of stack Lₕ; if d=0, goto step 5, else goto step 6;
5. store all the elements of stack Lₕ to the stack of solutions Lₛ;
6. set m′ equal to label of element stored on top of stack Lₕ; set d equal to value of d associated to that element; if d=0 or if flag=1 then retrieve the element on top of stack Lₕ and set flag=0; goto step 2;
7. if stack Lₕ is empty, then set flag=0 and goto step 8, else goto step 6;
8. set m=m+1; set m′=m; if m′>n exit, else goto step 2;

Before analyzing the complexity of this algorithm, it is useful to see it at work for the above example. For ease of illustration, one iteration of the algorithm is defined as an up-piling after one or more consecutive de-pilings of the stack Lₕ. The iterations which are gone through by the algorithm for the above example with d=127 are shown in the following table. The solutions are indicated by gray-shaded boxes. The arrows shall help to visualize the successive and recursive up- and de-piling of the stack Lₕ.

TABLE 1.1
2-dimensional up- and de-piling structure of the stack Lₕ

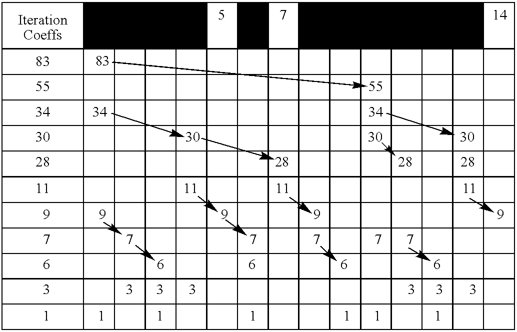

The attentive reader may have noticed that the working principle of the algorithm is based on a successive and recursive approximation of the given number d with as less coefficients as possible: for every solution found, a successive approximation is again applied to each coefficient of that solution, beginning with the smallest coefficient, which possibly generates new solutions for which a successive approximation is again applied . . . and so on, until all feasible approximations have been visited. The sets Σₖ associated to each coefficient improve the efficiency for determining all feasible approximations by terminating an ongoing approximation as soon as Σₖ<d.

In order to determine the complexity of the algorithm, an upper bound to the number of solutions is first determined and then the complexity for finding a solution is derived.

It is essential to see that the biggest number of solutions, and with that also the worst case number of iterations, is obtained for a list Lₒ of contiguous coefficients n, n−1, n−2 . . . 2, 1 and for a properly chosen number d, because in such a list every coefficient (except for the numbers 1 and 2) can be expressed as sum of two or more subsequent coefficients.

1. Extension to Identical Coefficients:

If there are m variables having identical coefficients of a same value v, then these m variables get temporarily replaced their m coefficients by temporary coefficients m·v, (m−1)·v, (m−2)·v . . . , 2·v, v in the list of original coefficients. Since any solution can only involve at most one of these temporary coefficients, as soon as and as long as one of these temporary coefficients has been put onto the stack Lₕ, all other temporary coefficients are ignored by subsequent searches. The rest of the algorithm remains unchanged. Any solution containing m·v as coefficient is a solution containing all of the m variables, a solution containing (m−1)·v as coefficient is a solution containing any m−1 pair-wise different variables selected from the m variables, a solution containing (m−2)·v as coefficient is a solution containing any m−2 pair-wise different variables selected from the m variables . . . and so on. The complexity of the algorithm remains unchanged.

Important Remark:

The extension to identical coefficients leads to solutions containing parameterized sub-sets in the form of ‘m-out-of-ss’, meaning that m pair-wise different variables have to be selected from the sub-set denoted by ss. Thus, the number of explicit solutions may be as large as (m·(m−1) . . . ·(m/2+1))/(m/2·(m/2−1) . . . ·1). In the following, the number m is called the ‘selection number’ of the parameterized sub-set ss.

2. Extension to Negative Coefficients

W.l.o.g. it is assumed that d>0. The extension to negative coefficients requires:
to generate two sorted lists of coefficients, a first list containing all positive coefficients in descending magnitude order (biggest coefficient first), and a second list containing all negative coefficients in descending magnitude order (biggest negative coefficient first)
to concatenate the two sorted lists into a single list Lₒ by joining the end of the first list to the start of the second list
to compute the sum Σ₋ of all negative coefficients, the sum Σₖ₊ of all positive coefficients in the first sorted list having labels >k, the sum Σₖ₋ of all negative coefficients in the second sorted list having labels >k
to modify step 2 and to add step 2′ in order to distinguish between a binary search either within the range of positive or negative coefficients:
2: if m′ denotes a positive coefficient, then do a binary search among all subsequent positive coefficients in the list Lₒ to find the member with smallest label, denoted by k, whose associated set Σₖ₊ satisfies Σₖ₊>=d and whose coefficient cₖ satisfies cₖ<=d−Σ₋; if k does not exist, set m′ equal to the label of the first negative coefficient in the list; goto step 2′;
2′: if m′ denotes a negative coefficient, then do a binary search among all subsequent negative coefficients in the list Lₒ to find the member with smallest label, denoted by k, whose associated set Σₖ₋ satisfies Σₖ₋<=d and whose coefficient cₖ satisfies cₖ>=d;

These modifications leave unchanged the way in which the stack Lₕ is up- and de-piled, and therefore also the worst case number of solutions O(n⁵) and the complexity of the algorithm O(n⁶·log n).

### EXAMPLE

An example with 7 positive and 4 negative coefficients for a given d=95 is summarized in the following table. Contrary to this example (which aims at showing similarity to the previous example), the magnitude of one or more negative coefficients may be greater than the magnitude of one or more positive coefficients.

TABLE 1.2
Example of finding the solution of a linear equation with negative coefficients.

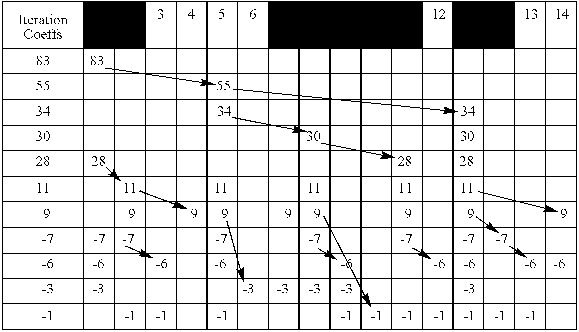

### EXAMPLE

The extensions to the algorithm can now be applied to find all parameterized solutions to the above regularized system with 2 equations, which is reproduced for convenience:

$$S {2}_{{i}^{′} , {j}^{′}} = \{ {x}_{2} , {x}_{3} , {x}_{6} , {x}_{7 } \} S {1}_{{i}^{′} , {j}^{′}} = \{ {x}_{1} , {x}_{4} , {x}_{5} \}$$

$${i}^{ ′} \text{:} - \overbrace{10 \cdot {x}_{2} - 10 \cdot {x}_{6} + 6 \cdot {x}_{3} + 6 \cdot {x}_{7 }} - \overbrace{{x}_{1} + 3 \cdot {x}_{4} - 3 \cdot {x}_{5}} = 1$$

$${j}^{ ′} \text{:} 4 \cdot {x}_{2} + 4 \cdot {x}_{6} - 2 \cdot {x}_{3} - 2 \cdot {x}_{7} + 3 \cdot {x}_{1} - {x}_{4} - 7 \cdot {x}_{5} = - 3$$

The 2 parameterized solutions of equation i′ are:
s_{1,i′}={x₁, 1-out-of-{x₂, x₆}, 2-out-of-{x₃, x₇}}
s_{2,i′}={x₁, 1-out-of-{x₂, x₆}, 2-out-of-{x₃, x₇}, x₄, x₅}

The 2 parameterized solutions of equation j′ are:
s_{1,j′}={2-out-of-{x₂, x₆}, 2-out-of-{x₃, x₇}, x₅}
s_{2,j′}={x₁, 1-out-of-{x₂, x₆}, 1-out-of-{x₃, x₇}, x₄, x₅}

Remark:

It is clear that a solution contains only those variables having a non-zero value. All other variables have a zero value.

Step 3: Determination of Solutions to the Whole System

After all the solutions of all k equations of the regularized system are computed, the problem of finding solutions to the whole system is equivalent in finding solutions which are common to all equations. The following definition and theorem is straightforward.

Definition and Theorem:

Consider any two equations i and j of the regularized system. A solution s is common to (e.g. satisfies) equations i and j iif there exists a solution sᵢ of equation i and a solution sⱼ of equation j such that sᵢ≡sⱼ≡s.

Proof:

Due to the fact that all variable-coefficients of the regularized system are non-zero, it is impossible that there exists a solution sᵢ of equation i and a solution sⱼ of equation j such that sᵢ≠sⱼ and either sᵢ⊂sⱼ or sᵢ⊃sⱼ holds. Therefore, a solution s satisfies both equations i and j iif sᵢ≡sⱼ≡s.□

Important Remark:

Two parameterized solutions sᵢ and sⱼ are identical iif the following 3 conditions are satisfied:
a. the variables appearing in both solutions are identical
b. the parameterized sub-sets are pair-wise identical
c. the selection numbers of the parameterized sub-sets are pair-wise identical

### EXAMPLE

A solution sᵢ={x₁, 1-out-of-{x₂, x₃, x₆}} is neither identical to sᵢ={x₁, 1-out-of-{x₂, x₆}}, nor to sᵢ={x₁, 2-out-of-{x₂, x₃, x₆}}, nor to sᵢ={x₁, 1−out-of-{x₂, x₃, x₆}, x₇}.

In order to determine all solutions of the regularized system, every solution of every equation is unequivocally converted into a binary number (1-to-1 mapping) by using the binary number representation format below.

This number representation format guarantees a 1-to-1 mapping because there are at most └n/2┘ sub-sets appearing in the set S2ₘᵢₙ and which are common to all equations of a regularized system. These sub-sets are labeled upwards from 1 . . . └n/2┘.

Binary Number Representation Format (└n/2┘·┌log n┐+n·┌log └n/2┘┐+2·n bits):

c₁, c₂ . . . c_{└n/2┘}, x₁, px₁, vx₁, x₂, px₂, vx₂ . . . xₙ, pxₙ, vxₙ

with:

cₘ m=1 . . . └n/2┘: specifies the number of variables to be selected from the parameterized sub-set with label m. E.g. 3-out-of-{x₁, x₂, x₄, x₅, x₆} would lead to cₘ=3. Since there are at most n members per sub-set, cₘ is encoded with ┌log n┐ bits.

xₘ m=1 . . . n: the value of variable xₘ (either 0 or 1) as given by a solution of an equation

pxₘ m=1 . . . n: specifies the label of parameterized sub-set to which variable xₘ belongs. Since there at most └n/2┘ parameterized sub-sets, pxₘ is encoded with ┌log └n/2┘┐ bits.

vxₘ m=1 . . . n: specifies whether variable xₘ belongs to a parameterized sub-set or not. If vxₘ=0, then pxₘ and cₘ are set to 0.

### EXAMPLE

The solution s_{1,i′}={x₁, 1-out-of-{x₂, x₆}, 2-out-of-{x₃, x₇}} of the regularized system example above would be converted into the following binary number:

c₁, c₂, c₃, x₁, px₁, vx₁, x₂, px₂, vx₂, x₃, px₃, vx₃, x₄, px₄, vx₄, x₅, px₅, vx₅, x₆, px₆, vx₆, x₇, px₇, vx₇=001, 010, 000, 1, 00, 0, 1, 00, 1, 1, 01, 1, 0, 00, 0, 0, 00, 0, 1, 00, 1, 1, 01, 1

The conversion of a solution into the above binary number representation has complexity O(n).

The converted solutions represent a list of numbers having each O(n·log n) bits. Thus, all solutions to the regularized system may be obtained by sorting this list and counting the numbers (e.g. the associated solutions) in the list appearing exactly k times. It is clear that if the list does not contain a number (e.g. a solution) appearing exactly k times, then the system has no solution. The same is true if an equation of the regularized system does not have a solution.

In a last step, only those solutions to the regularized system are retained which minimize the objective function. For this purpose, for each solution the corresponding value of the objective function is computed and the resulting values are put together with their associated solutions into a list. This list is then sorted according to ascending objective function values. The solutions which are retained are the first elements of the list having the same objective function value.

Important Remark:

It should be noted that, when computing the objective function value for a parameterized solution, the parameterized sub-sets appearing in the solution may get modified their selection numbers and may even disappear. Furthermore, new parameterized sub-sets may appear.

The following algorithm shows how to compute the objective function value t for a parameterized solution s and how to compute all new parameterized sub-sets ssₖ and selection numbers uₖ of the ‘modified’ solution s′. The algorithm distinguishes between the original parameterized sub-sets of solution s and the new parameterized sub-sets ssₖ of the modified solution s′. lₚ denotes the selection number of an original parameterized sub-set with label p.

In the following program notation, in analogy to the syntax of the programming language C++, the brackets {. . . } denote a group of statements to be executed sequentially. However, the brackets are also used to define and specify the empty set { } and the set {xₘ}.

Algorithm

1. Sort the coefficients cₘ (and associated variables) appearing in the objective function according to ascending coefficient values. If a coefficient appears several times in the list, then regroup the associated variables into a sub-set;

2. s′={ }; k=0; k′=0; For each coefficient cₘ (beginning with the first) in the sorted list do:

{ For each original sub-set p do : { if lₚ − qₚ > 0 then lₚ= lₚ − qₚ;

else lₚ=0;
qₚ=0; flagₚ =0;

}

k′ =k;
For each variable xₘ of the sub-set associated to cₘ do :

if xₘ∈s and xₘ belongs to an original sub-set p of solution s

then { if flagₚ = 0 then { flagₚ =1;

k=k+1;
define a new sub-set ssₖ :=
{ };
define a new uₖ := 0;

}

if flagₚ = 1 then if lₚ > 0 then { qₚ = qₚ +1; uₖ=
uₖ +1;

ssₖ = ssₖ ∪ { xₘ };

}

}

else if xₘ∈s then {s′ = s′ ∪ { xₘ }; t = t + cₘ ;}

For each new sub-set ss_{j=k...k′}do :

{ s′= s′ ∪ uₖ -out-of- ssₖ ; t = t + uₖ · cₘ ;}

}

It is straighfforward to verify that a new defined sub-set ssₖ can take its elements (e.g. variables) only from one original sub-set. The program variables uₖ, qₚ and flagₚ ensure that the sum of all variables of all those new sub-sets taken from a same original sub-set does not exceed the initial selection number lₚ of that original sub-set.

### EXAMPLE

Given is an objective function to minimize t=min Σ_{m=1 . . . n} cₘ·xₘ=min−7·x₁−4·x₂+2·x₃+x₄−5·x₅−4·x₆+2·x₇ for a given parameterized solution s={x₁, 1-out-of-{x₂, x₆}, 2-out-of-{x₃, x₄, x₅}}.

Sorting the coefficients appearing in the objective function yields the following list : {(−7, x₁), (−5, x₅), (−4,{x₂, x₆}), (1, x₄), (2, {x₃, x₇)}. In this list, the 2 sub-sets {x₂, x₆} and {x₃, x₇} are associated to the coefficients −5 and 2 respectively.

Applying the previous algorithm leads to t=−15 and s={x₁, 1-out-of-{x₂ , x₆}, x₄, x₅}.

Conditioning:

Considered is again the integer minimization problem from the beginning of this section. It is shown how the given system can be transformed into a conditioned system, e.g. a system having only non-zero variable-coefficients. Conditioning has complexity O(k·n²).

Instead of giving a formalalgorithm, it is more instructive to give a small constructive example from which the formal procedure and algorithm becomes obvious.

E.g. consider the following system of 3 equations:
2·x₁+x₃·x₅=1 1
+5·x₂−x₃−x₄=0 2
−x₁−3·x₂+x₄+x₅=0 3

First, equation 1 is substituted by an equation 1′ having only non-zero variable-coefficients. For this purpose, equation 1 is substituted by a linear combination of equations 1, 2 and 3. This may be written formally as 1′←a·1+b·2+c·3.

One has to determine the integers a, b and c such that all variable-coefficients of equation 1′ are non-zero. Since there are 5 variables, the integers a, b and c must satisfy at most 5 inequalities

$$2 \cdot a - c \neq 0$$

$$5 \cdot b - 3 \cdot c \neq 0$$

$$a - b \neq 0 \\ - b + c \neq 0 \\ - a + c \neq 0$$

In order to find a solution to these inequalities, one can start giving a an arbitrary non-zero value, e.g. a=1, and rewrite the 5 inequalities for a=1, which yields another 5 inequalities:

$$\begin{matrix} c \neq 2 \\ 5 \cdot b - 3 \cdot c \neq 0 \\ b \neq 1 \\ - b + c \neq 0 \\ c \neq 1\end{matrix}$$

There may appear at most 5 values to which b or c must be different. Therefore, b is given an arbitrary value which must be different to at most 5 values, e.g. one may choose b=0.2, and rewrite these inequalities for b=2, which yields another 5 inequalities:

$$\begin{matrix} c \neq 2 \\ c \neq 10 / 3 \\ b \neq 1 \\ c \neq 2 \\ c \neq 1\end{matrix}$$

Finally, there may appear at most 5 values to which c must be different. Therefore, c may be given an arbitrary value which is different to these 5 values, e.g. one may choose c=0.

It is clear that that this procedure may be repeated in order to substitute equations 2 and 3 by equations 2′ and 3′ which have only non-zero variable-coefficients. Therefore, in the general case of a system of k linear equations and n binary variables, O(n²) basic operations are required in order to make all variable-coefficients of one equation non-zero, and O(k·n²) operations for all k equations.

Concluding Remarks:

The complexity of the whole algorithm for solving the given integer minimization problem critically depends on the number of solutions found for each equation of the regularized system. The worst case number of solutions of an equation is only obtained for a list of contiguous coefficients n, n−1, n−2, . . . 1. If there are ‘holes’ in this list caused by identical or non-contiguous coefficients, the worst case number of solutions drops down dramatically. E.g. for randomly generated coefficients where almost no coefficient is the sum of two or more other coefficients, the worst case number of solutions per equation is likely to drop down to O(n). In this case, the total complexity of the whole algorithm is determined by the complexity of trans forming the given system into a regularized system, which is O(k·n²).

Furthermore, it is straightforward to verify that the algorithmic as described by this invention remains valid in the case that the coefficients are non-integer numbers, but fractional, rational or floating-point numbers.

### SUMMARY OF THE INVENTION

This invention describes a software method for computers for solving integer programming problems containing systems of linear equations where part of or all of the variables may take only integer values.

What is claimed is:

1. a software method for solving a system of linear equations having integer variables, where said method consists of doing the following 3 steps in the following order:
a. regularization of all or part of said equations of said system
b. computing the solutions for each equation of said system
c. determining solutions to said system by finding solutions which are common to all equations of said system

2. a software method as in claim 1, where the solutions of an equation of said system are determined by sorting two or more of the variable-coefficients of a said equation according to ascending or descending magnitude

3. a software method as in claim 1, where said system is conditioned prior to executing said 3 steps such every variable-coefficient of the conditioned system is non-zero

4. a software method as in claim 2, where said system is conditioned prior to executing said 3 steps such every variable-coefficient of the conditioned system is non-zero

5. a software method for solving a system of linear equations having integer variables, where the solutions of an equation of said system are determined by sorting two or more of the variable-coefficients of a said equation according to ascending or descending magnitude

6. a software method as in claim 5, where said system is conditioned prior to executing said 3 steps such any variable-coefficient of the conditioned system is non-zero

7. a software method as in claim 1, where one or more of said integer variables are binary variables

8. a software method as in claim 2, where one or more of said integer variables are binary variables

9. a software method as in claim 3, where one or more of said integer variables are binary variables

10. a software method as in claim 4, where one or more of said integer variables are binary variables

11. a software method as in claim 5, where one or more of said integer variables are binary variables

12. a software method as in claim 6, where one or more of said integer variables are binary variables
